(19) United States
(12) Patent Application Publication
(10) Pub. No.: US 2009/0200822 A1
(43) Pub. Date: Aug. 13, 2009

(54) MOBILE MORTUARY

(76) Inventor: Dwight Williams, Loganville, GA (US)

Correspondence Address: GEORGE R. REARDON, 3356 STATION COURT, LAWRENCVILLE, GA, 30044, US

(21) Appl. No.: 12/370,566

(22) Filed: Feb. 12, 2009

Related U.S. Application Data
(60) Provisional application No. 61/027,949, filed on Feb. 12, 2008.

(51) Int. Cl. B60P 3/20

(52) U.S. Cl. 296/24.35

(57) ABSTRACT

A mobile mortuary is disclosed. The self-contained mobile mortuary cooler provides the ability to respond to a scene having one or more deceased persons and to refrigerate the bodies immediately upon arrival. Elements of the mobile mortuary include a mobile carriage, a commercial refrigeration unit, a gasoline generator, an automatic transfer switch for A/C power, body racks with body straps, storage for body bags and other equipment directed to the responding to an accident or disaster scene, a body cot (gurney) and spine boards, structures for securing the body cot and spine boards, emergency scene lighting, emergency flashing hazard lights, an access assembly that facilitates entry of the gurney, air transport connectors and an assembly for releasable connection of an aircraft to the air transport connectors.

### FIELD OF THE INVENTION

The technology disclosed herein relates to the field of mobile cooling devices. In particular, the technology disclosed herein relates to a self-contained mobile walk-in cooler configured to serve as a mobile mortuary.

### BACKGROUND OF THE INVENTION

A mortuary, or morgue, traditionally has been a building or room (as in a hospital) used for the storage of human remains. The term morgue is derived from French morguer, which means ‘to look at solemnly, to defy’. The term was first used to describe the inner wicket of a prison, where prisoners were kept for some time, during which the jailers and turnkeys would spend time looking at the prisoners so that they would be able to recognize them. Relating to dead people, the name was first given to a building in Paris, which, in the middle of the fifth century, was part of the Châtelet and was used for the keeping and identification of unknown corpses.

There are two types of mortuary cold chambers:
Morgue—Positive temperature of +2/+4° C. which is the most usual for keeping the bodies a few days or a few weeks, but does not prevent decomposition of the corpse, which continues, albeit at a slow rate.
Morgue—Negative temperature of −15° C./−25° C. which is usual in forensic institutes, especially for bodies which have not yet been identified. At these temperatures, the body is completely frozen and decomposition totally halted.

The mortuary cold chamber is used to keep the deceased as long as is necessary for identification purposes, post-mortem examination, or while awaiting burial. In many countries, the family of the deceased must make the burial within 72 hours of death, but in some countries (in parts of Africa, for example) it is usual that the burial take place some weeks or some months after the death. This is why some corpses are kept as long as one or two years at a hospital or in a funeral home. When the family has enough money to organize the ceremony, they take the corpse from the cold chamber for burial.

In some funeral homes, the morgue is in the same room, or directly adjacent to, the specially designed ovens, known as retorts, that are used in funerary cremation. Some religions dictate that, should a body be cremated, the family must witness its incineration. To honor these religious rights, many funeral homes install a viewing window, which allows the family to watch as the body is inserted into the retort. In this way, the family can honor their customs without entering the morgue.

In many countries, the body of the deceased is embalmed, which makes refrigeration unnecessary.

A waiting mortuary is a mortuary building designed specifically for the purpose of confirming that deceased persons are truly deceased. Prior to the advent of modern methods of verifying death, people feared that they would be buried alive. To alleviate such fears, the recently deceased were housed for a time in waiting mortuaries, where attendants would watch for signs of life. The corpses would be allowed to decompose partially prior to burial. Waiting mortuaries were most popular in 19th century Germany, and were often large ornate halls. A bell was strung to the corpses to alert attendants of any motion.

Incidents involving murder, accidents, natural disasters (hurricanes, tornadoes, earthquakes, floods), acts of terror, military conflicts, etc., especially if there is loss of power and/or temperatures that accelerate body decomposition, create the need for a mobile mortuary that is equipped to cool the bodies. Cooling of a dead body as soon after death as possible is ideal both for forensics and preparation for burial. Since high temperatures and absence of electrical power may be common in these situations a need exists for a mobile mortuary that can operate independent of any need for an electrical source or a diesel power source.

Natural disasters and military conflicts present a logistical problem in that access to the deceased by surface transport is not available. Therefore there is a need for a mobile mortuary that is equipped for air transport to the location of the bodies, e.g. by a helicopter carrying the mobile mortuary using a releasable apparatus that connects the helicopter to the mobile mortuary.

These and other problems exist. Previous attempts to solve these and other problems include the following: U.S. Pat. Nos. 4,773,230, 5,285,604, 6,299,229, 7,406,834, and D544,815, all of which are incorporated by reference herein.

While these patents and other previous methods have attempted to solve the above mentioned problems, none have utilized or disclosed a self-contained mobile walk-in cooler that is configured to serve as an on-the-scene mobile mortuary as does the technology disclosed herein.

Therefore, a need exists for a mobile mortuary with these attributes and functionalities. The mobile mortuary according to the technology disclosed herein substantially departs from the conventional concepts and designs of the prior art. It can be appreciated that there exists a continuing need for new and improved mobile mortuaries which can be used commercially. In this regard, the technology disclosed herein substantially fulfills these objectives.

The foregoing patent and other information reflect the state of the art of which the inventor is aware and are tendered with a view toward discharging the inventor's acknowledged duty of candor in disclosing information that may be pertinent to the patentability of the technology disclosed herein. It is respectfully stipulated, however, that the foregoing patent and other information do not teach or render obvious, singly or when considered in combination, the inventor's claimed invention.

### BRIEF SUMMARY OF THE INVENTION

The general purpose of the technology disclosed herein, which will be described subsequently in greater detail, is to provide a self contained mobile walk-in mortuary cooler.

In particular, the technology disclosed herein relates to a self-contained mobile mortuary cooler that provides the ability to respond to an accident scene and refrigerate bodies immediately upon arrival. As forensic science becomes more technical and conclusive, the need for keeping bodies in pristine condition will become more important.

Elements of the mobile mortuary includes a mobile carriage, a commercial refrigeration unit, a gasoline generator, an automatic transfer switch for A/C power, stainless steel body racks with body straps and storage for body bags and other equipment directed to the responding to an accident or disaster scene.

Additional elements of the mobile mortuary include a body cot (gurney) and spine boards, structures for securing the body cot and spine boards, emergency scene lighting, emergency flashing hazard lights and an access assembly that facilitates entry of the gurney.

The mobile mortuary is made of heavy duty construction. The mobile mortuary is specifically comprised of four-inch thick rigid, chlorofluorocarbon-free, urethane form-in-place modular panels with 22-gauge embossed Galvalume® Plus skins to provide for outstanding thermal efficiency, accommodating temperatures ranging from as low as minus 40 degrees Fahrenheit to as high as 250 degrees Fahrenheit. This temperature efficiency range is aided by the fact that the Galvalume® Plus skins have an R-value, a measure of resistance to heat flow, of R-30, a high rating in terms of resistance to heat flow. One advantage of using GalValume® Plus skins is that such skins provide resistance to stains from storage and from transit corrosion. Additionally, the modular panels are comprised of tongue-and-groove panel edges, which keep the urethane insulation tightly joined together. Such edge technology ensures maximum insulating efficiency and structural integrity for the mobile mortuary. The mobile mortuary floor is comprised of a one-hundredth of an inch thick aluminum tread plate that is NSF approved. The aluminum tread plate floor surface is also easily cleaned and provides better traction and less slippage. The floor will support evenly distribute loads up to 750 pounds per square foot. The door panel of the mobile mortuary includes a door that is hinged on the right and includes a non positive latch with a cylinder lock. The door is has a width of 34 inches wide and a height 75 inches. Furthermore, the mobile mortuary door includes a safety mechanism to allow exit from the mobile mortuary even when the mobile mortuary door is padlocked. The mobile mortuary has a shatterproof interior for safety and efficiency. The mobile mortuary also comprises a vapor-proof light in its interior that is wired to an exterior weatherproof. The mobile mortuary can be manufactured in a variety of sizes, but three embodiments suggested are 1) a six foot width, eight foot length, and a seven and a half foot height; 2) a six foot width, twelve foot length and a seven and a half foot height; 3) a six foot width, sixteen foot length, and a seven and a half foot height; and 4) a eight foot width, sixteen foot length, and a seven and a half foot height. The mobile mortuary size is suitable to be permanently placed on the mobile carriage for easy transport.

The commercial refrigeration unit is comprised of a compressor, evaporator coil, refrigerant, and a refrigeration unit cover. Although the technology disclosed herein may utilize various compressors and evaporator coils, a preferred embodiment includes the use of a Copeland® compressor for the commercial refrigeration unit. A three quarter horsepower compressor is to be used on the coolers which are eight or twelve feet in length, and a one horsepower unit on a cooler that is sixteen foot in length. Additionally, the commercial refrigeration unit, in its preferred embodiment, is comprised of a Heatcraft™ evaporator coil. For the cooler to maintain a temperature of approximately 35 degrees Fahrenheit, the refrigerant R22 is used. Alternatively, for the cooler to maintain a temperature of approximately 0 degrees Fahrenheit, the refrigerant R404 is used. The refrigeration unit cover is placed over the portions of the commercial refrigeration unit that are located outside of the cooler. The refrigeration unit cover has a multitude of louvers located on each side for admitting air and ensuring adequate ventilation.

The commercial refrigeration unit is securely mounted to the cooler by means of a frame. This frame is saddled over the cooler front panel, allowing some components of the refrigeration unit system to be outside of the cooler and other co components of the refrigeration unit system to be inside the cooler. The frame is comprised of rectangular aluminum tubes and aluminum triangular plates to secure adjacent aluminum tubes for structural reinforcement. These triangular plates, as they are placed on the inside edge of the cooler front panel further provide support for the weight of the refrigeration unit.

The power unit system is comprised of a gasoline powered generator, a gasoline canister, and a generator housing unit. The generator housing unit is further comprised of a generator housing mounting tray, a generator housing cap, a generator housing battery box and battery hold down, and a receptacle for shoreline connection. The generator may be one of many in the marketplace; however, in the preferred embodiment of this technology disclosed herein, a gasoline-powered Honda EV4010 generator is used. This generator is a 4,000 Watt, 30 amp, 120 volt, 60 hertz, and twin-cylinder liquid cooled generator. Additionally such a generator is compact and quiet for use in the mobile mortuary. The gasoline canister has a capacity of 15 gallons of gasoline, providing a maximum of 22 hours of operation before the need to refuel arises. In addition to use with a gasoline-powered generator, the mobile mortuary may be use with a 120 volt, 20 amp shoreline connection. Furthermore, the power unit system of the mobile mortuary will automatically switch between the gasoline-powered generator and a shoreline power source. The power unit system has over-current protection. The power unit system also has a weather-proof duplex receptacle, providing two 120 volt electrical outlets for use as a receptacle for shoreline connection.

The mobile carriage system, by which the cooler is made mobile, is comprised of a trailer frame, two trailer axles, four trailer wheels, and four trailer tires. Although the trailer frame can be manufactured from various materials, those used in the preferred embodiment of the technology disclosed herein are noted. The trailer frame is constructed of five-inch steel “C” channel on the perimeter and three-inch steel “C” channel cross members. Additionally the trailer frame has a heavy-duty double-frame tongue. The two trailer axles are 5,200-pound Dexter Torflex® rubber suspension axles, providing independent wheel suspension, rubber cushioning, and shock absorption. Dexter electric brakes are used on each trailer axle. The trailer tires used in the preferred embodiment of the technology disclosed herein are LT225/75R-15, E. The trailer wheels in the preferred embodiment of the technology disclosed herein are chrome 15″×7″; 6 lug×5.5″ B.C. The trailer frame of the mobile carriage system is further comprised of LED running and clearance lights.

Desirably, the mobile mortuary is constructed and designed to be readily shipped to remote field locations by a transport carrier, such as: a helicopter, C140 cargo plane or other aircraft; ship; train; truck; or an all terrain vehicle. For airborne shipment and precision drop placement, the mobile mortuary comprises an impact-resistant composite panel system with sufficient structural strength and integrity to be dropped two feet by a helicopter or parachute without damaging or significantly impairing the operation and use of the containerized field kitchen and its contents. In order to enhance transport, the mobile mortuary comprises ISO corners mounting to ISO mobilizers. The mobile mortuary can be equipped with no-flat tires.

In one embodiment a mobile mortuary comprises: a cooler; a refrigeration unit system; a power unit system comprised of a gasoline-powered generator and a receptacle for shoreline connection, providing alternate power sources; a mobile carriage having no-flat tires; a first body rack; a second body rack; at least one body securing assembly disposed on the first body rack and the second body rack; at least one body transport assembly, e.g. a gurney; a securing assembly for the body transport assembly; at least one adjustable lighting assembly; at least one emergency light capable of flashing; at least one air transport connector, e.g. a receiving assembly for the grab hooks of a helicopter; and an aircraft connector assembly; wherein the second body rack has a storage compartment, where the storage compartment contains a plurality of body bags. The mobile mortuary can further comprise at least one set of forklift pockets for receiving tines of a forklift truck

One advantage of the technology described herein is that bodies are maintained in pristine condition for forensic analysis, especially when the outside temperature is conducive to rapid decomposing of a body.

Another advantage of the technology described herein is that multiple bodies can be stored for transport.

Another advantage of the technology described herein is that it facilitates body location and retrieval in unlit environments.

Another advantage of the technology described herein is that it provides quick access to equipment and supplies related to an accident or disaster scene.

Another advantage of the technology described herein is that it provides for multiple options for transport to the desired location.

There has thus been outlined, rather broadly, the more important features of the technology disclosed herein in order that the detailed description thereof that follows may be better understood, and in order that the present contribution to the art may be better appreciated. There are additional features of the technology disclosed herein that will be described hereinafter and which will form the subject matter of the claims appended hereto. In this respect, before explaining at least one embodiment of the technology disclosed herein in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology disclosed herein. It is important, therefore, that the claims be regarded as including such equivalent constructions insofar as they do not depart from the spirit and scope of the technology disclosed herein.

Further objects and advantages of the technology disclosed herein will be apparent from the following detailed description of a presently preferred embodiment which is illustrated schematically in the accompanying drawings.

### BRIEF DESCRIPTION OF THE SEVERAL VIEWS OF THE DRAWINGS

Other advantages and features of the technology disclosed herein are described with reference to exemplary embodiments, which are intended to explain and not to limit the technology disclosed herein, and are illustrated in the drawings in which:

FIG. 1 is a perspective view of a mobile mortuary according to an embodiment of the technology disclosed herein.

FIG. 2 is a back, planar view of a mobile mortuary according to an embodiment of the technology disclosed herein.

FIG. 3 is a left side, planar view of a mobile mortuary according to an embodiment of the technology disclosed herein.

FIG. 4 is a back side, planar view of a mobile mortuary according to an embodiment of the technology disclosed herein.

FIG. 5 is a top, planar view of a mobile mortuary according to an embodiment of the technology disclosed herein.

FIG. 6 is a right side, planar view of a mobile mortuary according to an embodiment of the technology disclosed herein.

FIG. 7 is a top, cross-sectional view of a mobile mortuary according to an embodiment of the technology disclosed herein.

FIG. 8 is a perspective view of a mobile mortuary, without the cooler top panel according to an embodiment of the technology disclosed herein.

FIG. 9 is an exploded view of a mobile mortuary according to an embodiment of the technology disclosed herein.

FIG. 10 is a perspective view of a frame according to an embodiment of the technology disclosed herein.

FIG. 11 is a side, planar view of a frame according to an embodiment of the technology disclosed herein.

FIG. 12 is a top, planar view of a frame according to an embodiment of the technology disclosed herein.

FIG. 13 is a front, planar view of a frame according to an embodiment of the technology disclosed herein.

FIG. 14 is a front, perspective view of a refrigeration unit cover according to an embodiment of the technology disclosed herein.

FIG. 15 is a rear, perspective view of a refrigeration unit cover according to an embodiment of the technology disclosed herein.

FIG. 16 is a front, planar view of a refrigeration unit cover according to an embodiment of the technology disclosed herein.

FIG. 17 is a top, planar view of a refrigeration unit cover according to an embodiment of the technology disclosed herein.

FIG. 18 is a bottom, planar view of a refrigeration unit cover according to an embodiment of the technology disclosed herein.

FIG. 19 is a side, planar view of a refrigeration unit cover according to an embodiment of the technology disclosed herein.

FIG. 20 is a front, perspective view of a refrigeration unit bottom according to an embodiment of the technology disclosed herein.

FIG. 21 is a front, perspective view of a generator housing cap according to an embodiment of the technology disclosed herein.

FIG. 22 is a front, perspective view of a generator housing mounting tray according to an embodiment of the technology disclosed herein.

FIG. 23 is a front, perspective view of a power unit system according to an embodiment of the technology disclosed herein.

FIG. 24 is a front, perspective view of a generator housing battery box according to an embodiment of the technology disclosed herein.

FIG. 25 is a front, perspective view of a battery hold-down according to an embodiment of the technology disclosed herein.

FIG. 26 is a side plan view of a gurney according to an embodiment of the technology disclosed herein.

FIG. 27 is a perspective view of one configuration of a body rack according to an embodiment of the technology disclosed herein.

FIG. 28 is a perspective view of another configuration of a body rack according to an embodiment of the technology disclosed herein.

FIG. 29 is a rear exploded view of a mobile mortuary illustrating emergency lighting, body racks, a gurney and an access assembly according to an embodiment of the technology disclosed herein.

### DETAILED DESCRIPTION OF THE INVENTION

Before explaining the disclosed embodiment of the technology disclosed herein in detail it is to be understood that the invention is not limited in its application to the details of the particular arrangement shown since the invention is capable of other embodiments. Also, the terminology used herein is for the purpose of description and not of limitation.

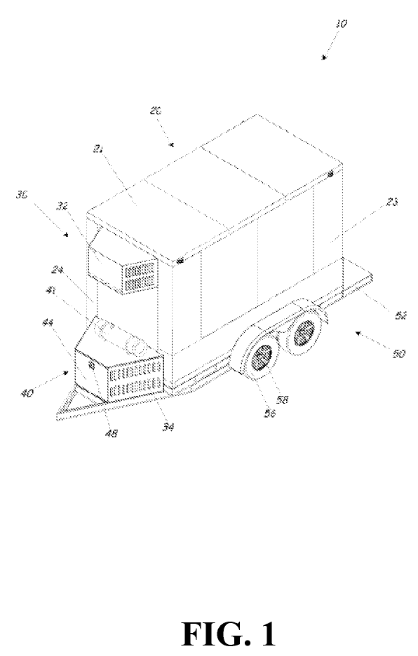

Referring now to FIG. 1, a perspective view of a mobile mortuary, 10, is shown. The mobile mortuary, 10, is comprised of a cooler, 20, a refrigeration unit system, 30, a power unit system, 40, to provide power to the refrigeration unit system, 30, when a permanent power source is unavailable, and a mobile carriage system, 50, for quick and easy transport. The cooler, 20, is made of heavy duty construction.

The cooler, 20, is specifically comprised of four-inch thick rigid, chlorofluorocarbon-free, urethane form-in-place modular panels: the cooler top panel, 21, the cooler door panel, the cooler front panel, 24, two cooler side panels, 23, and a cooler floor. The cooler, 20, panels are manufactured with 22-gauge embossed Galvalume® Plus skins to provide for outstanding thermal efficiency, accommodating temperatures ranging from as low as minus 40 degrees Fahrenheit to as high as 250 degrees Fahrenheit. This temperature efficiency range is aided by the fact that the Galvalume® Plus skins have an R-value, a measure of resistance to heat flow, of R-30, a high rating in terms of resistance to heat flow. One advantage of using GalValume® Plus skins is that such skins provide resistance to stains from storage and from transit corrosion. Additionally, the modular panels are comprised of tongue-and-groove panel edges, which keep the urethane insulation tightly joined together. Such edge technology ensures maximum insulating efficiency and structural integrity for the cooler. The cooler floor is comprised of a one-hundredth of an inch thick aluminum tread plate that is NSF approved. The aluminum tread plate floor surface is also easily cleaned and provides better traction and less slippage. The cooler floor will support evenly distribute loads up to 750 pounds per square foot. The cooler, 20, has a shatterproof interior for safety and efficiency. The cooler, 20, also comprises a vapor-proof light in its interior that is wired to an exterior weatherproof. The cooler, 20, can be manufactured in a variety of sizes, but three embodiments suggested are 1) a six foot width, eight foot length, and a seven and a half foot height 2) a six foot width, twelve foot length and a seven and a half foot height and 3) a six foot width, sixteen foot length, and a seven and a half foot height. The cooler, 20, size is suitable to be permanently placed on the mobile carriage system, 50, for easy transport.

The refrigeration unit system, 30, is comprised of a compressor, evaporator coil, refrigerant, and a refrigeration unit cover, 32. Although the technology disclosed herein may utilize various compressors and evaporator coils, a preferred embodiment includes the use of a Copeland® compressor for the refrigeration unit. A three quarter horsepower compressor is to be used on a cooler, 20, which is eight or twelve feet in length, and a one horsepower unit on a cooler, 20, that is sixteen foot in length. Additionally, the refrigeration unit, in its preferred embodiment, is comprised of a Heatcraft™ evaporator coil. For the cooler, 20, to maintain a temperature of approximately 35 degrees Fahrenheit, the refrigerant, R22, is used. Alternatively, for the cooler to maintain a temperature of approximately 0 degrees Fahrenheit, the refrigerant, R404, is used. The refrigeration unit cover, 32, is placed over the portions of the refrigeration unit that are located outside of the cooler, 20. The refrigeration unit cover, 32, has a multitude of louvers, 34, located on each side for admitting air and ensuring adequate ventilation.

The power unit system, 40, is comprised of a gasoline powered generator, a gasoline canister, 41, and a generator housing, 44. The generator housing, 44, is further comprised of a generator housing mounting tray, a generator housing cap, a generator housing battery box and battery hold down, and a receptacle for shoreline connection, 48. The gasoline-powered generator may be one of many in the marketplace; however, in the preferred embodiment of the technology disclosed herein, a gasoline-powered Honda EV4010 generator is used. This gasoline-powered generator is a 4,000 Watt, 30 amp, 120 volt, 60 hertz, and twin-cylinder liquid cooled generator. Additionally such a generator is compact and quiet for use in the mobile mortuary, 10. The gasoline canister, 41, has a capacity of 15 gallons of gasoline, providing a maximum of 22 hours of operation before the need to refuel arises. In addition to use with a gasoline-powered generator, the mobile mortuary, 10, may be use with a 120 volt, 20 amp shoreline connection. Furthermore, the power unit system, 40, of the mobile mortuary, 10, will automatically switch between the gasoline-powered generator and a shoreline power source. The power unit system, 40, has over-current protection. The power unit system, 40, also has a weather-proof duplex receptacle, providing two 120 volt electrical outlets for use as a receptacle for shoreline connection.

The mobile carriage system, 50, by which the cooler, 20, is made mobile, is comprised of a trailer frame, 52, two trailer axles, 54, four trailer wheels, 58, and four trailer tires, 56. Although the trailer frame, 52, can be manufactured from various materials, those used in the preferred embodiment of the technology disclosed herein are noted. The trailer frame, 52, is constructed of five-inch steel “C” channel on the perimeter and three-inch steel “C” channel cross members. Additionally the trailer frame, 52, has a heavy-duty double-frame tongue. The two trailer axles, 54, are 5,200-pound Dexter Torflex® rubber suspension axles, providing independent wheel suspension, rubber cushioning, and shock absorption. Dexter electric brakes are used on each trailer axle, 54. The trailer tires, 56, used in the preferred embodiment of the technology disclosed herein are LT225/75R-15, E. The trailer wheels, 58, in the preferred embodiment of the technology disclosed herein are chrome 15″×7″; 6 lug×5.5″ B.C. The trailer frame, 52, of the mobile carriage system, 50, is further comprised of LED running and clearance lights for traffic safety.

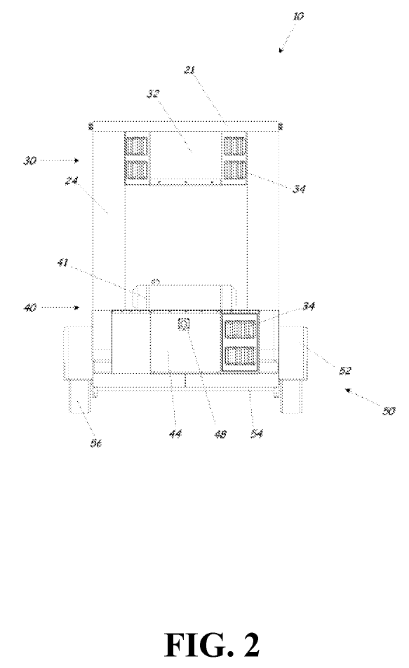

Referring now to FIG. 2, a back, planar view of a mobile mortuary, 10, is shown. Two panels of the cooler, 20, are illustrated in this drawing: the cooler front panel, 24, and the cooler top panel, 21. The refrigeration unit system, 30, is illustrated with a refrigeration unit cover, 32, which is placed over the portions of the refrigeration unit that are located outside of the cooler, 20. The refrigeration unit cover, 32, also has a multitude of louvers, 34, located on each side for admitting air and ensuring adequate ventilation. The power unit system, 40, is shown with a gasoline powered generator, a gasoline canister, 41, a receptacle for shoreline connection, 48, and a generator housing, 44, with a multitude of louvers, 34, located on each side for admitting air and ensuring adequate ventilation. The mobile carriage system, 50, by which the cooler, 20, is made mobile, is illustrated with of a trailer frame, 52, trailer axles, 54, and trailer tires, 56.

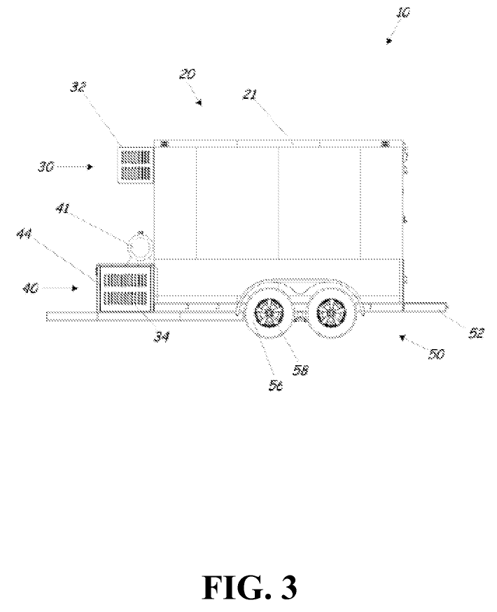

Referring now to FIG. 3, a left side, planar view of a mobile mortuary, 10, is shown. The cooler, 20, is illustrated with the cooler top panel, 21. The refrigeration unit system, 30, is illustrated with a refrigeration unit cover, 32, which is placed over the portions of the refrigeration unit that are located outside of the cooler, 20. The refrigeration unit cover, 32, also has a multitude of louvers, 34, located on each side for admitting air and ensuring adequate ventilation. The power unit system, 40, is shown with a gasoline powered generator, a gasoline canister, 41, and a generator housing, 44, with a multitude of louvers, 34, located on each side for admitting air and ensuring adequate ventilation. The mobile carriage system, 50, by which the cooler, 20, is made mobile, is illustrated with of a trailer frame, 52, trailer wheels, 58, and trailer tires, 56.

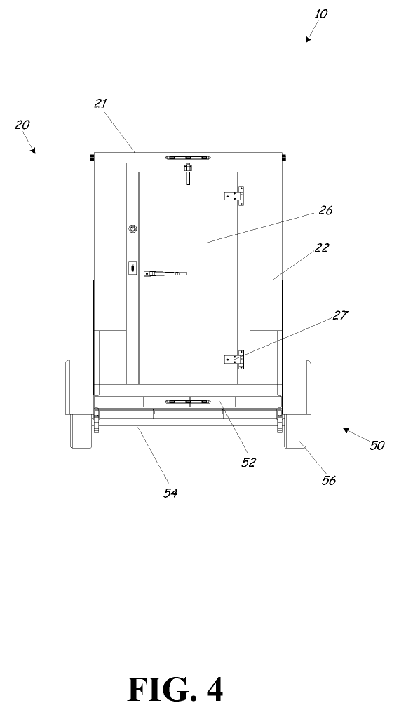

Referring now to FIG. 4, a back side, planar view of a mobile mortuary, 10, is shown. Two panels of the cooler, 20, are illustrated in this drawing: the cooler door panel, 22, and the cooler top panel, 21. The cooler door, 26, is shown in the cooler door panel, 22. The cooler door panel, 22, of the cooler, 20, includes a cooler door, 26, that is hinged on the right, with a cooler door hinge, 27, at both the top-right and bottom-right sides. The cooler door, 26, also includes a non positive latch with a cylinder lock. The cooler door, 26, is has a width of 34 inches wide and a height 75 inches. Furthermore, the cooler door, 26, includes a safety mechanism to allow exit from the cooler, 20, even when the cooler door, 26, is padlocked. The mobile carriage system, 50, by which the cooler, 20, is made mobile, is illustrated with of a trailer frame, 52, trailer axles, 54, and trailer tires, 56.

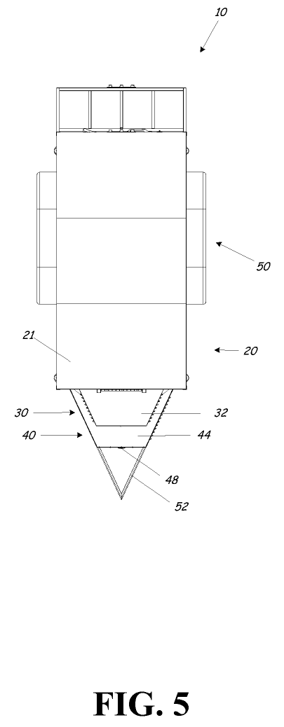

Referring now to FIG. 5 a top, planar view of a mobile mortuary, 10, is shown. The cooler, 20, is illustrated with the cooler top panel, 21. The refrigeration unit system, 30, is illustrated with a refrigeration unit cover, 32, which is placed over the portions of the refrigeration unit that are located outside of the cooler, 20. The power unit system, 40, is shown with a receptacle for shoreline connection, 48, and a generator housing, 44. The mobile carriage system, 50, by which the cooler, 20, is made mobile, is illustrated with a trailer frame, 52.

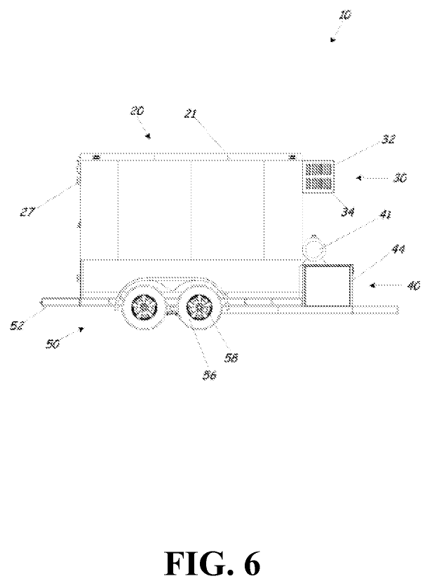

Referring now to FIG. 6, a right side, planar view of a mobile mortuary, 10, is shown. The cooler, 20, is illustrated with the cooler top panel, 21. The cooler, 20, is also shown with the cooler door hinges, 27. The refrigeration unit system, 30, is illustrated with a refrigeration unit cover, 32, which is placed over the portions of the refrigeration unit that are located outside of the cooler, 20. The refrigeration unit cover, 32, also has a multitude of louvers, 34, located on each side for admitting air and ensuring adequate ventilation. The power unit system, 40, is shown with a gasoline canister, 41, and a generator housing, 44. The mobile carriage system, 50, by which the cooler, 20, is made mobile, is illustrated with of a trailer frame, 52, trailer wheels, 58, and trailer tires, 56.

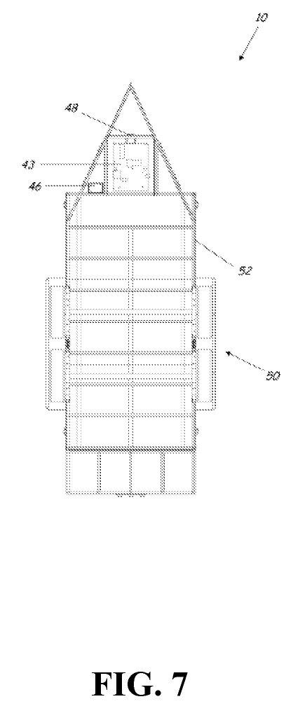

Referring now to FIG. 7, a top, cross-sectional view of a mobile mortuary, 10, is shown. The generator housing mounting tray, 43, the generator housing battery box, 46, and the receptacle for shoreline connection, 48, are shown. The mobile carriage system, 50, by which the cooler, 20, is made mobile, is illustrated with of a trailer frame, 52.

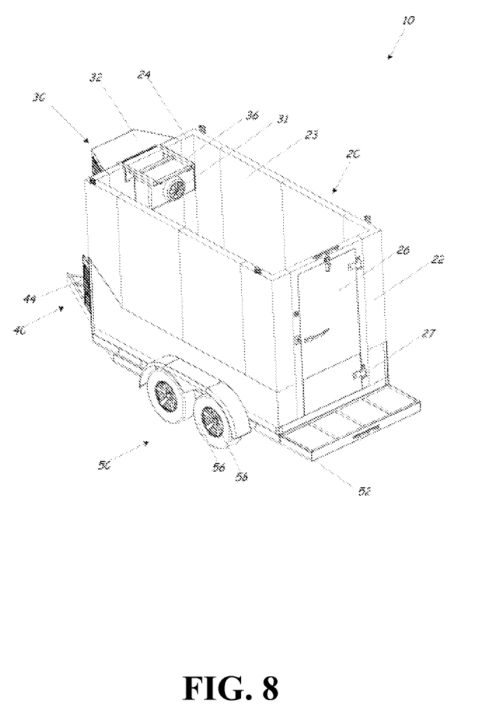

Referring now to FIG. 8, a perspective view of a mobile mortuary, 10, is shown without the cooler top panel. The cooler, 20, is specifically comprised of four-inch thick rigid, chlorofluorocarbon-free, urethane form-in-place modular panels. The cooler door panel, 22, the cooler front panel, 24, the two cooler side panels, 23, and a cooler door, 26, located within the cooler door panel, 22, are shown. The cooler door panel, 22, of the cooler, 20, includes a cooler door, 26, that is hinged on the right, with a cooler door hinge, 27, at both the top-right and bottom-right sides. The cooler door, 26, also includes a non positive latch with a cylinder lock. The cooler door, 26, has a width of 34 inches wide and a height 75 inches. Furthermore, the cooler door, 26, includes a safety mechanism to allow exit from the cooler, 20, even when the cooler door, 26, is padlocked. The refrigeration unit system, 30, is illustrated with a refrigeration unit cover, 32, which is placed over the portions of the refrigeration unit that are located outside of the cooler, 20, and a frame, 36, with which the refrigeration unit, 31, is suspended. The commercial refrigeration unit is securely mounted to the cooler by means of a frame, 36. This frame, 36, is saddled over the cooler front panel, 24, allowing some components of the refrigeration unit system, 30, to be outside of the cooler, 20, and other co components of the refrigeration unit system, 30, to be inside the cooler, 20. The frame, 36, is comprised of rectangular aluminum tubes and aluminum triangular plates to secure adjacent aluminum tubes for structural reinforcement. These triangular plates, as they are placed on the inside edge of the cooler front panel, 24, further provide support for the weight of the refrigeration unit, 31. The power unit system, 40, is shown with a generator housing, 44. The mobile carriage system, 50, by which the cooler, 20, is made mobile, is illustrated with of a trailer frame, 52, trailer wheels, 58, and trailer tires, 56.

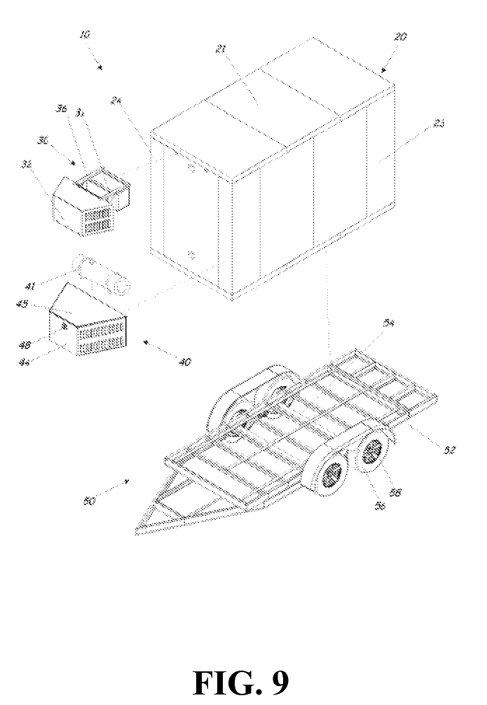

Referring now to FIG. 9, an exploded view of a mobile mortuary, 10, is shown. The cooler, 20, is shown with the cooler front panel, 24, a cooler side panel, 23, and a cooler top panel, 21. The refrigeration unit system, 30, is illustrated with a refrigeration unit cover, 32, which is placed over the portions of the refrigeration unit that are located outside of the cooler, 20, and a frame, 36, with which the refrigeration unit, 31, is suspended. The commercial refrigeration unit is securely mounted to the cooler by means of a frame, 36. This frame, 36, is saddled over the cooler front panel, 24, allowing some components of the refrigeration unit system, 30, to be outside of the cooler, 20, and other co components of the refrigeration unit system, 30, to be inside the cooler, 20. The frame, 36, is comprised of rectangular aluminum tubes and aluminum triangular plates to secure adjacent aluminum tubes for structural reinforcement. These triangular plates, as they are placed on the inside edge of the cooler front panel, 24, further provide support for the weight of the refrigeration unit, 31. The power unit system, 40, is shown with a gasoline canister, 41, a generator housing, 44, a generating housing cap, 45, and a receptacle for shoreline connection, 48. The mobile carriage system, 50, by which the cooler, 20, is made mobile, is illustrated with of a trailer frame, 52, trailer axles, 54, trailer wheels, 58, and trailer tires, 56.

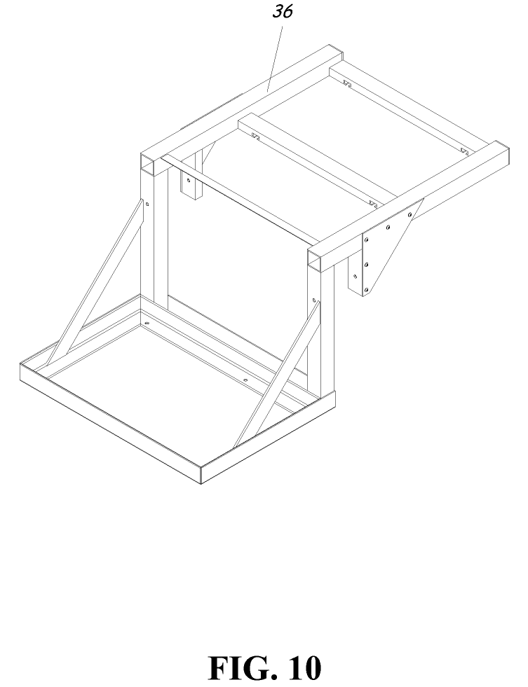

Referring now to FIG. 10, a perspective view of a frame, 36, is shown. The commercial refrigeration unit is securely mounted to the cooler by means of a frame, 36. This frame, 36, is saddled over the cooler front panel, allowing some components of the refrigeration unit system to be outside of the cooler and other co components of the refrigeration unit system to be inside the cooler. The frame, 36, is comprised of rectangular aluminum tubes and aluminum triangular plates to secure adjacent aluminum tubes for structural reinforcement. These triangular plates, as they are placed on the inside edge of the cooler front panel further provide support for the weight of the refrigeration unit.

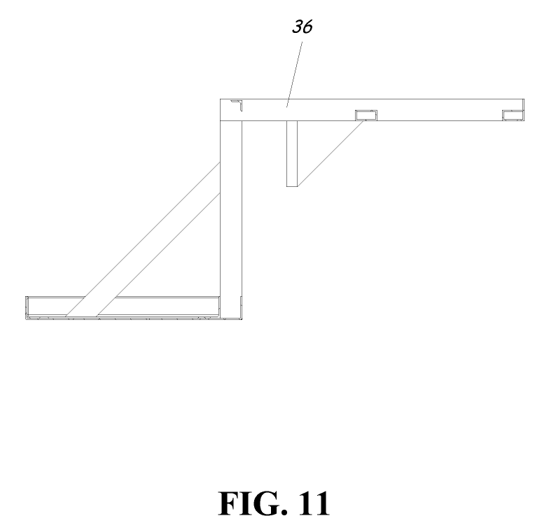

Referring now to FIG. 11, a side, planar view of a frame, 36, is shown. This frame, 36, is saddled over the cooler front panel, allowing some components of the refrigeration unit system to be outside of the cooler and other co components of the refrigeration unit system to be inside the cooler.

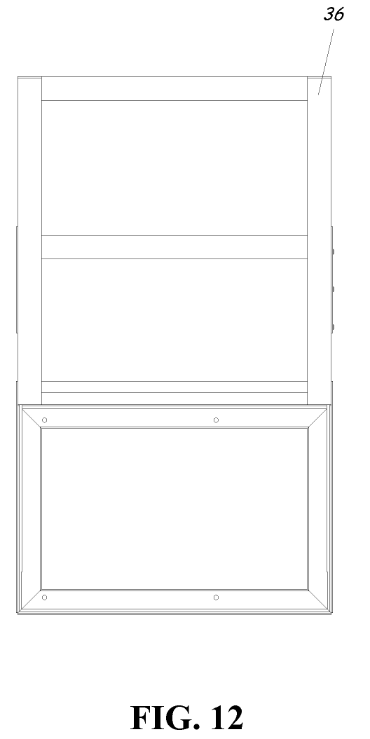

Referring now to FIG. 12, a top, planar view of a frame, 36, is shown. The frame, 36, is comprised of rectangular aluminum tubes and aluminum triangular plates to secure adjacent aluminum tubes for structural reinforcement. These triangular plates, as they are placed on the inside edge of the cooler front panel further provide support for the weight of the refrigeration unit.

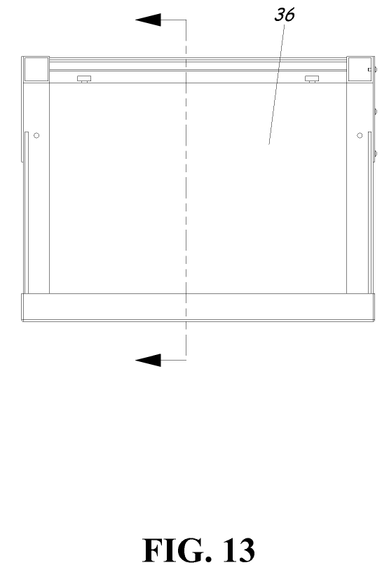

Referring now to FIG. 13, a front, planar view of a frame, 36, is shown.

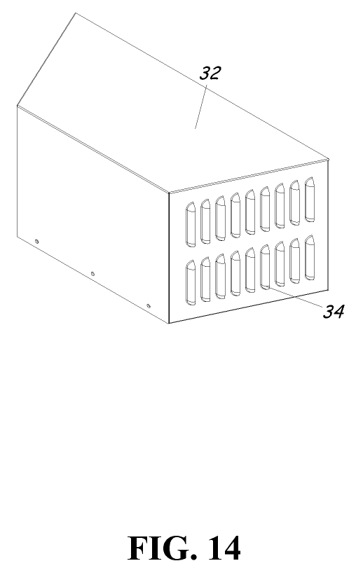

Referring now to FIG. 14, a front, perspective view of a refrigeration unit cover, 32, is shown. The refrigeration unit cover, 32, has louvers, 34, on each side to provide ventilation. The refrigeration unit cover, 32, is a component of the refrigeration unit system.

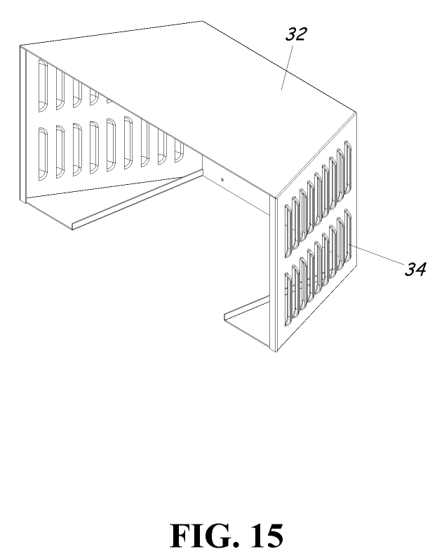

Referring now to FIG. 15, a rear, perspective view of a refrigeration unit cover, 32, is shown. The refrigeration unit cover, 32, has louvers, 34, on each side to provide ventilation. The refrigeration unit cover, 32, is a component of the refrigeration unit system.

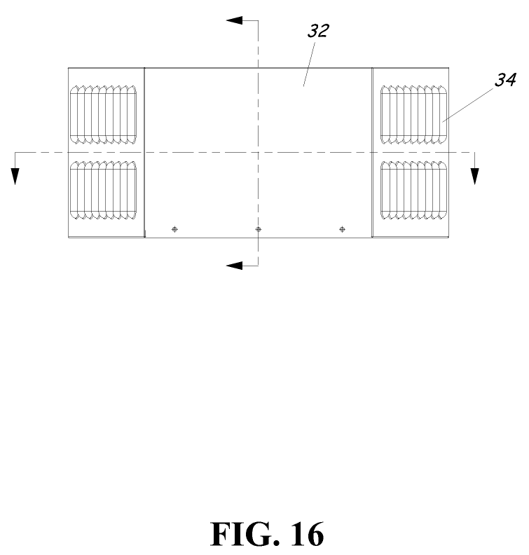

Referring now to FIG. 16, a front, planar view of a refrigeration unit cover, 32, is shown. The refrigeration unit cover, 32, has louvers, 34, on each side to provide ventilation. The refrigeration unit cover, 32, is a component of the refrigeration unit system.

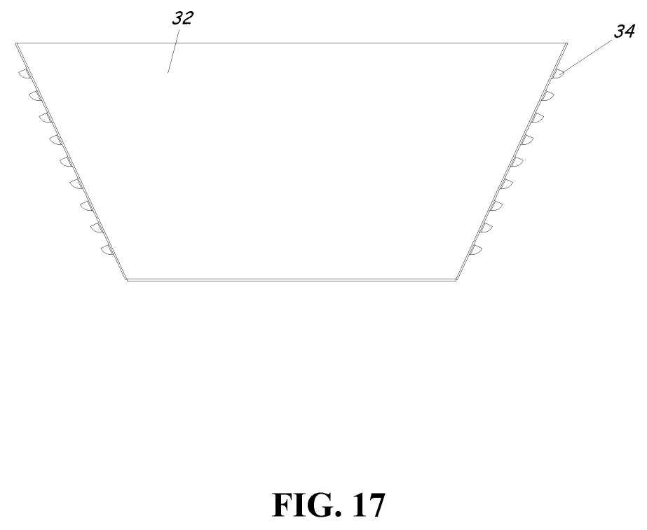

Referring now to FIG. 17, a top, planar view of a refrigeration unit cover, 32, is shown. The refrigeration unit cover, 32, has louvers, 34, on each side to provide ventilation. The refrigeration unit cover, 32, is a component of the refrigeration unit system.

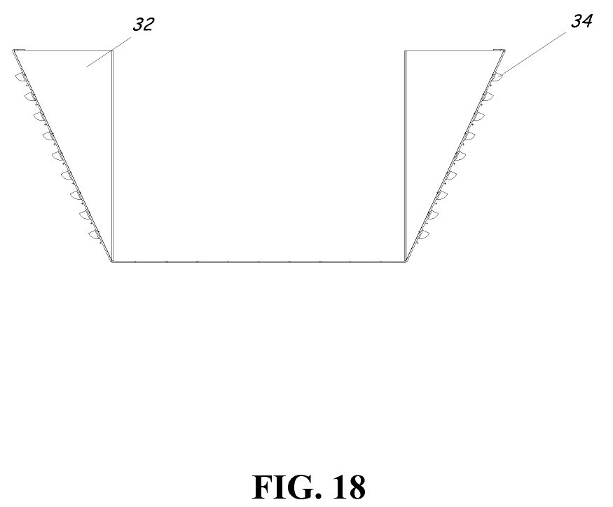

Referring now to FIG. 18, a bottom, planar view of a refrigeration unit cover, 32, is shown. The refrigeration unit cover, 32, has louvers, 34, on each side to provide ventilation. The refrigeration unit cover, 32, is a component of the refrigeration unit system.

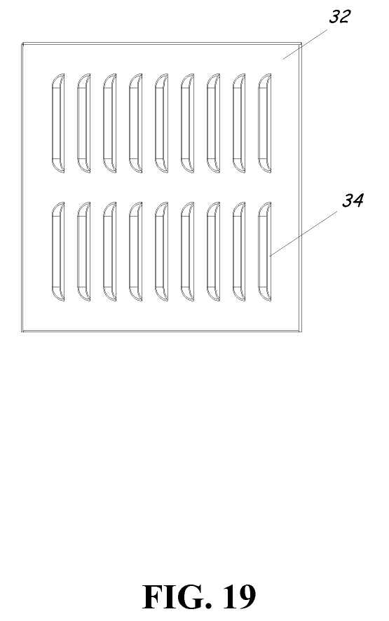

Referring now to FIG. 19, a side, planar view of a refrigeration unit cover, 32, is shown. The refrigeration unit cover, 32, has louvers, 34, on each side to provide ventilation. The refrigeration unit cover, 32, is a component of the refrigeration unit system.

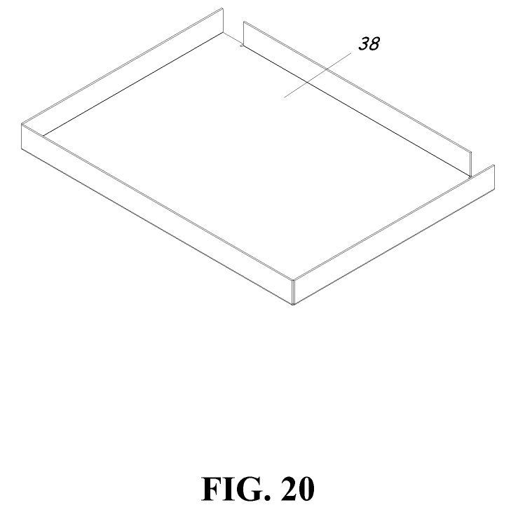

Referring now to FIG. 20, a front, perspective view of a refrigeration unit bottom, 38, is shown. The refrigeration unit bottom, 38, is a component of the refrigeration unit system and supports the refrigeration unit.

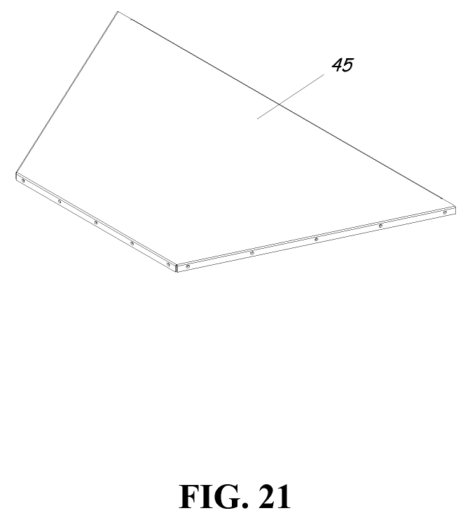

Referring now to FIG. 21, a front, perspective view of a generator housing cap, 45, is shown. The generator housing cap, 45, is a component of the power unit system and its generator housing. The generator housing cap, 45, is mounted on top of the generator housing.

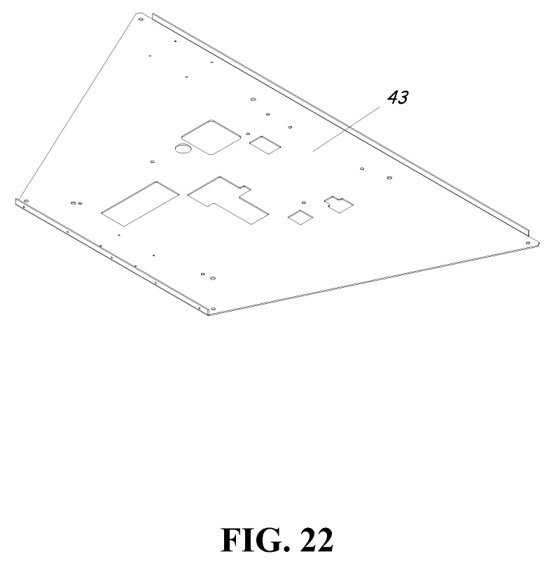

Referring now to FIG. 22, a front, perspective view of a generator housing mounting tray, 43, is shown. The generator housing mounting tray, 43, is a component of the power unit system and its generator housing.

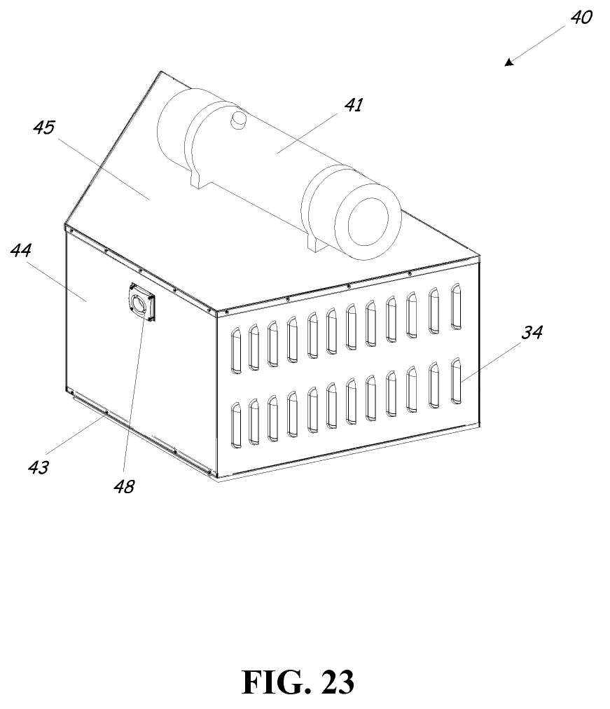

Referring now to FIG. 23, a front, perspective view of a power unit system, 40, is shown. The power unit system, 40, is comprised of a gasoline powered generator, a gasoline canister, 41, a generator housing, 44, a generator housing mounting tray, 43, a generator housing cap, 45, and a receptacle for shoreline connection, 48. The generator housing, 44, has a multitude of louvers, 34, to provide ventilation.

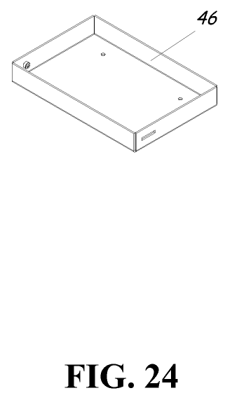

Referring now to FIG. 24, a front, perspective view of a generator housing battery box, 46, is shown. The generator housing battery box, 46, used in combination with the battery hold-down, secures an automobile battery within the generator housing of the power unit system.

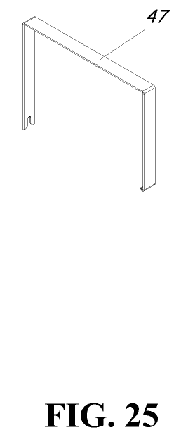

Referring now to FIG. 25, a front, perspective view of a battery hold-down, 47, is shown. The battery hold-down, 47, is used as bracket to secure an automobile battery to the generator housing battery box located within the generator housing of the power unit system.

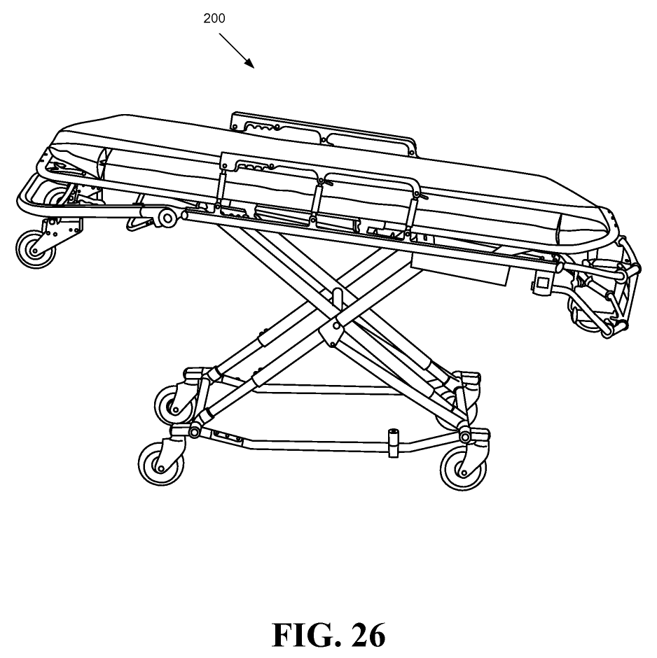

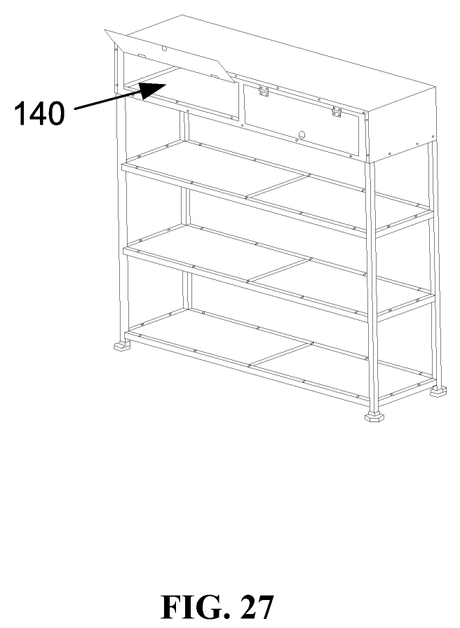

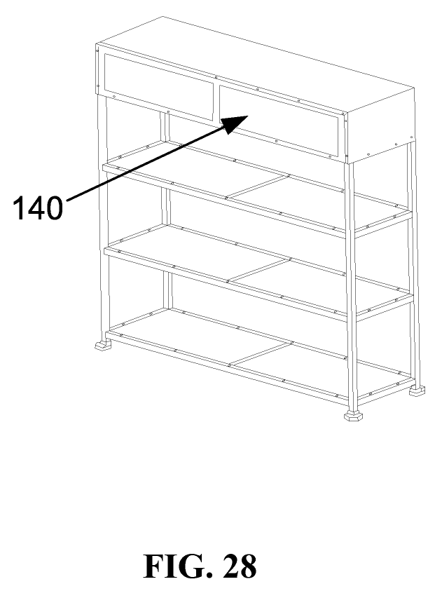

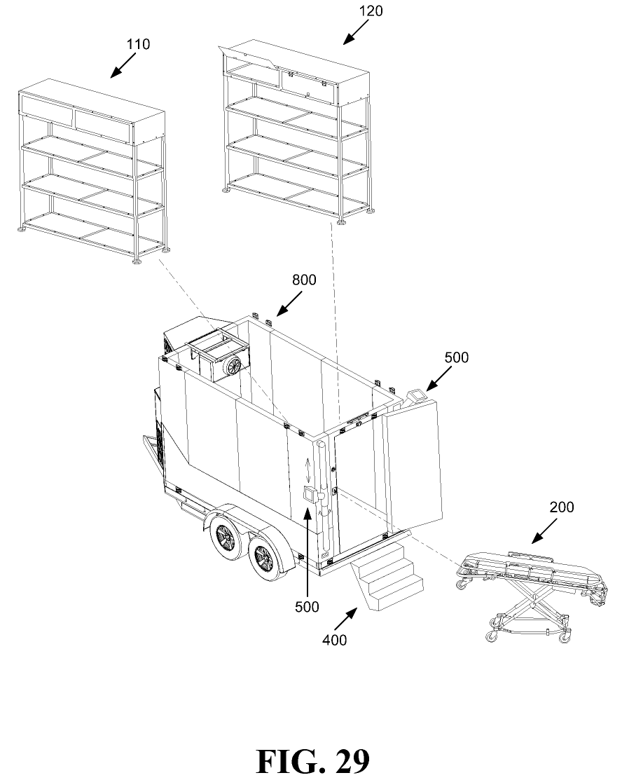

Referring now to FIG. 26 through FIG. 29, the mobile mortuary 10 is further comprised of a first body rack 110 and a second body rack 120. Each body rack is dimensioned for holding at least one body on each shelf level. Each body rack is equipped with at least one of a body securing assembly 130 (not shown), e.g. a strap assembly. In an exemplary embodiment, the second body rack 120 is formed to have a storage compartment 140. The storage compartment 140 contains a plurality of a body bag, as well as other mobile mortuary accessories. The mobile mortuary 10 is further comprised of at least one of a gurney 200 and a gurney securing assembly 300 (not shown). The mobile mortuary 10 is further comprised of a gurney ramp and step assembly 400. The mobile mortuary 10 is further comprised of a plurality of an adjustable lighting assembly 500, e.g. a telescoping and rotating light to illuminate the area around the mobile mortuary. The mobile mortuary 10 is further comprised of a plurality of an air transport connector 600, e.g. a heavy duty eyelet assembly. The mobile mortuary 10 is further comprised of an aircraft connector 700 (not shown), e.g. a grappling hook assembly. The mobile mortuary 10 is further comprised of a plurality of emergency flashing lights 800.

An embodiment of the technology disclosed herein is made as follows: The mobile mortuary, 10, is comprised of a cooler, 20, a refrigeration unit system, 30, a power unit system, 40, to provide power to the refrigeration unit system, 30, when a permanent power source is unavailable, and a mobile carriage system, 50, for quick and easy transport. The cooler, 20, is made of heavy duty construction. The cooler, 20, is specifically comprised of four-inch thick rigid, chlorofluorocarbon-free, urethane form-in-place modular panels: the cooler top panel, 21, the cooler door panel, the cooler front panel, 24, two cooler side panels, 23, and a cooler floor. The cooler, 20, panels are manufactured with 22-gauge embossed Galvalume® Plus skins to provide for outstanding thermal efficiency, accommodating temperatures ranging from as low as minus 40 degrees Fahrenheit to as high as 250 degrees Fahrenheit. This temperature efficiency range is aided by the fact that the Galvalume® Plus skins have an R-value, a measure of resistance to heat flow, of R-30, a high rating in terms of resistance to heat flow. One advantage of using GalValume® Plus skins is that such skins provide resistance to stains from storage and from transit corrosion. Additionally, the modular panels are comprised of tongue-and-groove panel edges, which keep the urethane insulation tightly joined together. Such edge technology ensures maximum insulating efficiency and structural integrity for the cooler. The cooler floor is comprised of a one-hundredth of an inch thick aluminum tread plate that is NSF approved. The aluminum tread plate floor surface is also easily cleaned and provides better traction and less slippage. The cooler floor will support evenly distribute loads up to 750 pounds per square foot. The cooler, 20, has a shatterproof interior for safety and efficiency. The cooler, 20, also comprises a vapor-proof light in its interior that is wired to an exterior weatherproof. The cooler, 20, can be manufactured in a variety of sizes, but three embodiments suggested are 1) a six foot width, eight foot length, and a seven and a half foot height 2) a six foot width, twelve foot length and a seven and a half foot height and 3) a six foot width, sixteen foot length, and a seven and a half foot height. The cooler, 20, size is suitable to be permanently placed on the mobile carriage system, 50, for easy transport. The refrigeration unit system, 30, is comprised of a compressor, evaporator coil, refrigerant, and a refrigeration unit cover, 32. Although the technology disclosed herein may utilize various compressors and evaporator coils, a preferred embodiment includes the use of a Copeland® compressor for the refrigeration unit. A three quarter horsepower compressor is to be used on a cooler, 20, which is eight or twelve feet in length, and a one horsepower unit on a cooler, 20, that is sixteen foot in length. Additionally, the refrigeration unit, in its preferred embodiment, is comprised of a Heatcraft™ evaporator coil. For the cooler, 20, to maintain a temperature of approximately 35 degrees Fahrenheit, the refrigerant, R22, is used. Alternatively, for the cooler to maintain a temperature of approximately 0 degrees Fahrenheit, the refrigerant, R404, is used. The refrigeration unit cover, 32, is placed over the portions of the refrigeration unit that are located outside of the cooler, 20. The refrigeration unit cover, 32, has a multitude of louvers, 34, located on each side for admitting air and ensuring adequate ventilation. The power unit system, 40, is comprised of a gasoline powered generator, a gasoline canister, 41, and a generator housing, 44. The generator housing, 44, is further comprised of a generator housing mounting tray, a generator housing cap, a generator housing battery box and battery hold down, and a receptacle for shoreline connection, 48. The gasoline-powered generator may be one of many in the marketplace; however, in the preferred embodiment of the technology disclosed herein, a gasoline-powered Honda EV4010 generator is used. This gasoline-powered generator is a 4,000 Watt, 30 amp, 120 volt, 60 hertz, and twin-cylinder liquid cooled generator. Additionally such a generator is compact and quiet for use in the mobile mortuary, 10. The gasoline canister, 41, has a capacity of 15 gallons of gasoline, providing a maximum of 22 hours of operation before the need to refuel arises. In addition to use with a gasoline-powered generator, the mobile mortuary, 10, may be use with a 120 volt, 20 amp shoreline connection. Furthermore, the power unit system, 40, of the mobile mortuary, 10, will automatically switch between the gasoline-powered generator and a shoreline power source. The power unit system, 40, has over-current protection. The power unit system, 40, also has a weather-proof duplex receptacle, providing two 120 volt electrical outlets for use as a receptacle for shoreline connection. The mobile carriage system, 50, by which the cooler, 20, is made mobile, is comprised of a trailer frame, 52, two trailer axles, 54, four trailer wheels, 58, and four trailer tires, 56. Although the trailer frame, 52, can be manufactured from various materials, those used in the preferred embodiment of the technology disclosed herein are noted. The trailer frame, 52, is constructed of five-inch steel “C” channel on the perimeter and three-inch steel “C” channel cross members. Additionally the trailer frame, 52, has a heavy-duty double-frame tongue. The two trailer axles, 54, are 5,200-pound Dexter Torflex® rubber suspension axles, providing independent wheel suspension, rubber cushioning, and shock absorption. Dexter electric brakes are used on each trailer axle, 54. The trailer tires, 56, used in the preferred embodiment of the technology disclosed herein are LT225/75R-15, E. The trailer wheels, 58, in the preferred embodiment of the technology disclosed herein are chrome 15″×7″; 6 lug×5.5″ B.C. The trailer frame, 52, of the mobile carriage system, 50, is further comprised of LED running and clearance lights for traffic safety.

The foregoing description and drawings comprise illustrative embodiments of the technology disclosed herein. Having thus described exemplary embodiments of the technology disclosed herein, it should be noted by those skilled in the art that the within disclosures are exemplary only, and that various other alternatives, adaptations and modifications may be made within the scope of the technology disclosed herein. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the technology disclosed herein is not limited to the specific embodiments illustrated herein, but is limited only by the following claims.

What is claimed is:

1. A mobile mortuary comprising:
a cooler;
a refrigeration unit system;
a power unit system comprised of a gasoline-powered generator and a receptacle for shoreline connection, providing alternate power sources;
a mobile carriage having no-flat tires;
a first body rack;
a second body rack;
at least one body securing assembly disposed on the first body rack and the second body rack;
at least one body transport assembly;
a securing assembly for the body transport assembly;
at least one adjustable lighting assembly;
at least one emergency light capable of flashing;
at least one air transport connector; and
an aircraft connector assembly;
wherein the second body rack has a storage compartment,
wherein the storage compartment contains a plurality of body bags.

2. The mobile mortuary of claim 1, further comprising:
at least one set of forklift pockets for receiving tines of a forklift truck
